(19) United States
(12) Patent Application Publication
(10) Pub. No.: US 2012/0169754 A1
(43) Pub. Date: Jul. 5, 2012

(54) METHOD AND APPARATUS FOR PROVIDING SYNTHESIZABLE GRAPHICS FOR USER TERMINALS

(75) Inventors: Mika Pesonen, Sunnyvale, CA (US); Eero Aho, Tampere (FI); Jari Nikara, Lempaala (FI)

(73) Assignee: Nokia Corporation

(21) Appl. No.: 12/981,836

(22) Filed: Dec. 30, 2010

(51) Int. Cl. G09G 5/00

(52) U.S. Cl. 345/582; 345/619

(57) ABSTRACT

A method for providing synthesizable graphics for user terminals may include receiving, at a user terminal, graphics information provided wirelessly from a tag associated with an object within communication range of the tag, processing the graphics information at the user terminal to determine graphics data based on the graphics information received, and causing generation of display graphics to be rendered at a display of the user terminal based on the graphics data. A corresponding apparatus and computer program product are also provided.

### TECHNOLOGICAL FIELD

An embodiment of the present invention relates generally to user interface technology and, more particularly, relates to a method and apparatus for providing synthesizable graphics for user terminals.

### BACKGROUND

Communication devices are becoming increasingly ubiquitous in the modern world. In particular, mobile communication devices seem to be popular with people of all ages, socio-economic backgrounds and sophistication levels. Accordingly, users of such devices are becoming increasingly attached to their respective mobile communication devices. Whether such devices are used for calling, emailing, sharing or consuming media content, gaming, navigation or various other activities, people are more connected to their devices and consequently more connected to each other and to the world at large.

Due to advances in processing power, memory management, application development, power management and other areas, communication devices, such as computers, mobile telephones, cameras, multimedia internet devices (MIDs), personal digital assistants (PDAs), media players and many others are becoming more capable. Moreover, the popularity and utility of mobile communication devices has caused many people to rely on their mobile communication devices to connect them to the world for personal and professional reasons. Thus, many people carry their mobile communication devices with them on a nearly continuous basis.

As with numerous other types of property, many mobile communication device owners have a desire to personalize their respective devices. Wallpapers, ring tones and removable device skins have been common mechanisms used by individuals to personalize their devices. However, these mechanisms are primarily static and difficult or even somewhat costly to replace. Accordingly, it may be desirable to develop improved ways to personalize devices.

### BRIEF SUMMARY

A method, apparatus and computer program product are therefore provided to enable the provision of synthesizable graphics for user terminals. In this regard, for example, some embodiments may provide for the use of a near field communication (NFC) tag to provide information for impacting data displayed by a mobile terminal when the user terminal is proximate to the tag.

In one example embodiment, a method of providing synthesizable graphics for user terminals is provided. The method may include receiving, at a user terminal, graphics information provided wirelessly from a tag associated with an object within communication range of the tag, processing the graphics information at the user terminal to determine graphics data based on the graphics information received, and causing generation of display graphics to be rendered at a display of the user terminal based on the graphics data.

In another example embodiment, an apparatus for providing synthesizable graphics for user terminals is provided. The apparatus may include at least one processor and at least one memory including computer program code. The at least one memory and the computer program code may be configured to, with the at least one processor, cause the apparatus to perform at least receiving, at a user terminal, graphics information provided wirelessly from a tag associated with an object within communication range of the tag, processing the graphics information at the user terminal to determine graphics data based on the graphics information received, and causing generation of display graphics to be rendered at a display of the user terminal based on the graphics data.

In one example embodiment, another apparatus for providing synthesizable graphics for user terminals is provided. The apparatus may include means for receiving, at a user terminal, graphics information provided wirelessly from a tag associated with an object within communication range of the tag, means for processing the graphics information at the user terminal to determine graphics data based on the graphics information received, and means for causing generation of display graphics to be rendered at a display of the user terminal based on the graphics data.

In one example embodiment, a computer program product for providing synthesizable graphics for user terminals is provided. The computer program product may include at least one computer-readable storage medium having computer-executable program code instructions stored therein. The computer-executable program code instructions may include program code instructions for receiving, at a user terminal, graphics information provided wirelessly from a tag associated with an object within communication range of the tag, processing the graphics information at the user terminal to determine graphics data based on the graphics information received, and causing generation of display graphics to be rendered at a display of the user terminal based on the graphics data.

An example embodiment of the invention may provide a method, apparatus and computer program product for employment in mobile environments or in fixed environments. As a result, for example, mobile terminal and other computing device users may enjoy an improved ability to personalize their devices and express themselves via their devices.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a wireless communications system according to an example embodiment of the present invention;

FIG. 2 illustrates a block diagram of an apparatus for providing synthesizable graphics for user terminals according to an example embodiment of the present invention;

FIG. 3, which includes FIGS. 3A and 3B, illustrates graphical displays that may be generated to mimic the surroundings of the mobile device according to an example embodiment; and

FIG. 4 is a flowchart according to an example method for providing synthesizable graphics for user terminals according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of synthesizable graphics for mobile terminals. In this regard, for example, a near field communication (NFC) tag may be used to provide information to a mobile terminal that becomes proximate to the NFC tag. The information may include program code and/or data that may describe graphical information to be displayed by a display device of the mobile terminal. In some cases (although not necessarily in all), the graphical information may be displayed on a secondary display such as, for example, an ink display (e.g., an e-ink display, an electronic paper display, or the like). The secondary display may, in some examples, be provided in the form of a skin for all or a portion of the mobile terminal. However, some embodiments may simply present the graphical information on the main display of the mobile terminal.

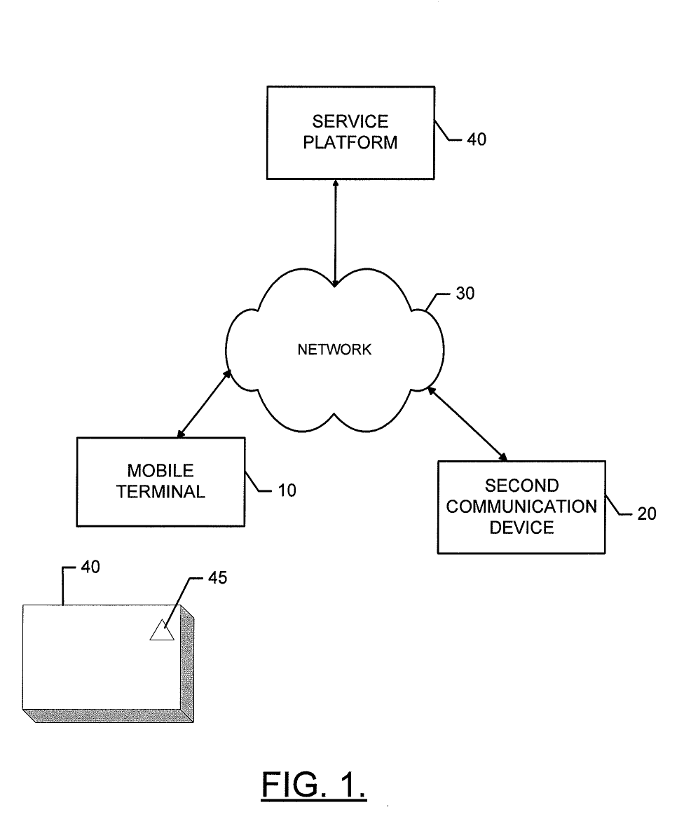

FIG. 1 illustrates a generic system diagram in which a device such as a mobile terminal 10, which may benefit from some embodiments of the present invention, is shown in an example communication environment. As shown in FIG. 1, a system in accordance with an example embodiment of the present invention includes a first communication device (e.g., mobile terminal 10) and a second communication device 20 that may each be capable of communication with a network 30. The second communication device 20 is provided as an example to illustrate potential multiplicity with respect to instances of other devices that may be included in the network 30 and that may practice an example embodiment. The communications devices of the system may be able to communicate with network devices or with each other via the network 30. In some cases, the network devices with which the communication devices of the system communicate may include a service platform 40. In an example embodiment, the mobile terminal 10 (and/or the second communication device 20) is enabled to communicate with the service platform 40 to provide, request and/or receive information.

While an example embodiment of the mobile terminal 10 may be illustrated and hereinafter described for purposes of example, numerous types of mobile terminals, such as portable digital assistants (PDAs), pagers, mobile televisions, mobile telephones, gaming devices, laptop computers, cameras, camera phones, video recorders, audio/video player, radio, electronic books, global positioning system (GPS) devices, navigation devices, or any combination of the aforementioned, and other types of multimedia, voice and text communications systems, may readily employ an example embodiment of the present invention. Furthermore, devices that are not mobile may also readily employ an example embodiment of the present invention in some cases. As such, for example, the second communication device 20 may represent an example of a fixed electronic device that may employ an example embodiment. For example, the second communication device 20 may be a personal computer (PC) or other terminal.

In some embodiments, not all systems that employ embodiments of the present invention may comprise all the devices illustrated and/or described herein. For example, while an example embodiment will be described herein in which either a mobile user device (e.g., mobile terminal 10), a fixed user device (e.g., second communication device 20), or a network device (e.g., the service platform 40) may include an apparatus capable of performing some example embodiments in connection with communication with the network 30, it should be appreciated that some embodiments may exclude one or multiple ones of the devices or the network 30 altogether and simply be practiced on a single device (e.g., the mobile terminal 10 or the second communication device 20) in a stand alone mode.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be capable of communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the second communication device 20 via the network 30. By directly or indirectly connecting the mobile terminal 10, the second communication device 20 and other devices to the network 30, the mobile terminal 10 and the second communication device 20 may be enabled to communicate with the other devices (or each other), for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including USB, LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing device. The service platform 40 may have any number of functions or associations with various services. As such, for example, the service platform 40 may be a platform such as a dedicated server (or server bank) associated with a particular information source or service (e.g., a power and/or computing load management service), or the service platform 40 may be a backend server associated with one or more other functions or services. As such, the service platform 40 represents a potential host for a plurality of different services or information sources. In some embodiments, the functionality of the service platform 40 is provided by hardware and/or software components configured to operate in accordance with known techniques for the provision of information to users of communication devices. However, at least some of the functionality provided by the service platform 40 may be information provided in accordance with an example embodiment of the present invention.

In some embodiments, the mobile terminal 10 (or the second communication device 20) may be within a predetermined distance of an object 40 that may have a communication tag 45 (e.g., an NFC tag) positioned thereon or otherwise associated therewith. The predetermined distance may be defined as a function of the range at which the communication tag 45 can be read by the mobile terminal 10. In some cases, the mobile terminal 10 may move to a position close to (or in contact with) the object 40. However, in other examples, the object 40 may actually be moved close to (or in contact with) the mobile terminal 10. As yet another alternative, both the object 40 and the mobile terminal 10 may be moving and they may come within the predetermined distance of each other. In any case, when the mobile terminal 10 is within the predetermined distance of the object 40 communication may be established between the mobile terminal 10 and the communication tag 45 (e.g., by any suitable mechanism such as via a NFC protocol or communication channel) at least momentarily such that the mobile terminal 10 may obtain graphical display information from the communication tag 45 and then generate graphical data for display at the mobile terminal 10 as described herein.

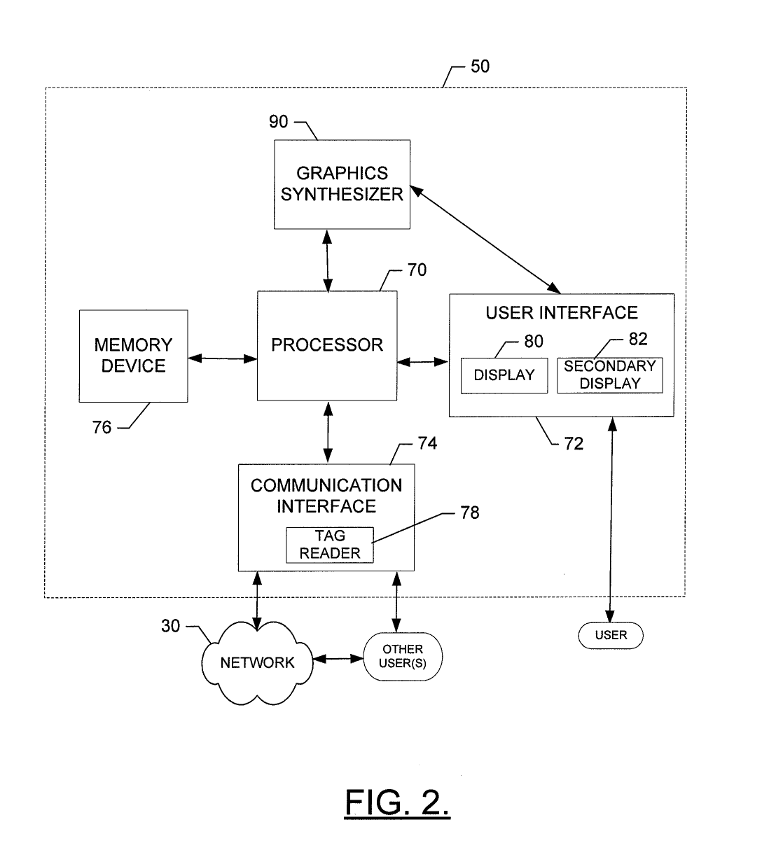

FIG. 2 illustrates a schematic block diagram of an apparatus for providing synthesizable graphics for user terminals according to an example embodiment of the present invention. An example embodiment of the invention will now be described with reference to FIG. 2, in which certain elements of an apparatus 50 for providing synthesizable graphics for user terminals are displayed. The apparatus 50 of FIG. 2 may be employed, for example, on the service platform 40, on the mobile terminal 10 and/or on the second communication device 20. However, the apparatus 50 may alternatively be embodied at a variety of other devices, both mobile and fixed (such as, for example, any of the devices listed above). In some cases, an embodiment may be employed on either one or a combination of devices. Accordingly, some embodiments of the present invention may be embodied wholly at a single device (e.g., the service platform 40, the mobile terminal 10 or the second communication device 20), by a plurality of devices in a distributed fashion or by devices in a client/server relationship (e.g., the mobile terminal 10 and the service platform 40). Furthermore, it should be noted that the devices or elements described below may not be mandatory and thus some may be omitted in certain embodiments.

Referring now to FIG. 2, an apparatus for providing synthesizable graphics for user terminals is provided. The apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied in hardware as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), central processing unit (CPU), a hardware accelerator, a vector processor, a graphics processing unit (GPU), a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, or a combination of hardware and software, that is configured to receive and/or transmit data from/to a network and/or any other device or module in communication with the apparatus. In this regard, the communication interface 74 may include, for example, an antenna (or multiple antennas such as at least one antenna supporting NFC) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms. In embodiments where an antenna is provided for reading an NFC or other communication tag (e.g., communication tag 45), the communication interface 74 may include a tag reader 78 that may be configured to interface with a passive or active communication tag using NFC or other short range communication techniques in order to read information therefrom.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10 or the second communication device 20), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the user interface 72 may include a display 80 as shown in FIG. 2. The display 80 may be a main display or the only display associated with the apparatus 50. Thus, for example, in some cases the display 80 may take up substantially one whole side or face of a device (e.g., the mobile terminal 10) in the form of a touch screen display. In some example embodiments (but not necessarily all), the user interface 72 may include a secondary display 82. The secondary display 82 may be a smaller display than the main display of a mobile terminal. In some embodiments, the display 80 and/or the secondary display 82 may be an ink display, e-ink display, e-paper display, electronic paper display, or the like. Moreover, the secondary display 82 may be formed as a skin over a portion (or even substantially all normally exposed portions) of the mobile terminal 10.

In an exemplary embodiment, the processor 70 may be embodied as, include or otherwise control a graphics synthesizer 90. As such, in some embodiments, the processor 70 may be said to cause, direct or control the execution or occurrence of the various functions attributed to the graphics synthesizer 90 as described herein. The graphics synthesizer 90 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the graphics synthesizer 90 as described herein. Thus, in examples in which software is employed, a device or circuitry (e.g., the processor 70 in one example) executing the software forms the structure associated with such means.

In an example embodiment, the graphics synthesizer 90 may generally be configured to receive indications of graphics information read from a tag (e.g., communication tag 45) by the tag reader 78, and generate graphics for display at either or both of the display 80 or the secondary display 82 based on graphical data determined from the graphics information. Thus, for example, in some cases, the graphics synthesizer 90 may read in and execute code descriptive of graphical data itself that instructs the rendering of graphics (e.g., colors, shapes, patterns, images, video sequences, and/or the like) to be displayed at the display 80 or the secondary display 82. However, in some examples, the graphics synthesizer 90 may be configured to download information (e.g., from the service platform 40 or another web site identified from the graphics information received) descriptive of the graphics to be displayed at the display 80 or the secondary display 82.

As indicated above, the tag (e.g., communication tag 45) may be associated with any of a plurality of different objects (e.g., object 40). The objects may be mobile or stationary and the tags themselves may include graphics information including program code and data that may be downloaded to any device (e.g., the mobile terminal 10) that enters into proximity with the object (and thereby also the tag). The program code may be any of numerous types of code including, for example, OpenGL shader code, OpenCL kernel code, JavaScript code, Python code and/or the like. The data may include small texture patterns or other graphics data that may be used to generate displayable material to be rendered at the display 80 or secondary display 82 of the device that reads the program code and data of the graphics information. In some cases, the mobile terminal 10 may touch the object (or tag) in order to initiate the download, but in others the download may be initiated when the mobile terminal 10 and the tag are within a predetermined distance from each other.

After the graphics information including the program code and/or the data is loaded at the reading device (e.g., the mobile terminal 10), the program code may be compiled (e.g., for code that needs to be compiled such as OpenGL, OpenCL or the like) and executed, or may simply be executed without compilation for interpretable languages (e.g., JavaScript, Python, etc.). The graphic data corresponding to the graphical information downloaded may then be used by the graphics synthesizer 90 to render images, textures, colors, shading, shapes, video sequences and/or the like to one or more display interfaces (e.g., the display 80 and/or the secondary display 82).

In an example embodiment where the secondary display 82 is an ink display, the ink display may be provided over a significant portion of the casing or housing of the mobile terminal 10. Thus, for example, the secondary display 82 may act as a skin for the mobile terminal 10. However, unlike other skins that may be purchased and attached to a mobile terminal 10 to provide a fixed expression or personalization, the secondary display 82 may form a dynamically expressive skin. The dynamically expressive capabilities of the secondary display 82 may be realized by virtue of the fact that the secondary display 82 may generate graphical displays that are determined based on information received from objects (or more particularly from tags associated with each object). The graphical displays that may be generated can be used to mimic the surroundings of the mobile terminal 10 via graphics rendered at the display 80 and/or the secondary display 82 (e.g., providing a chameleon-like effect of adapting to the surroundings of the mobile terminal 10) or to respond to a theme defined for the object or associated with the object.

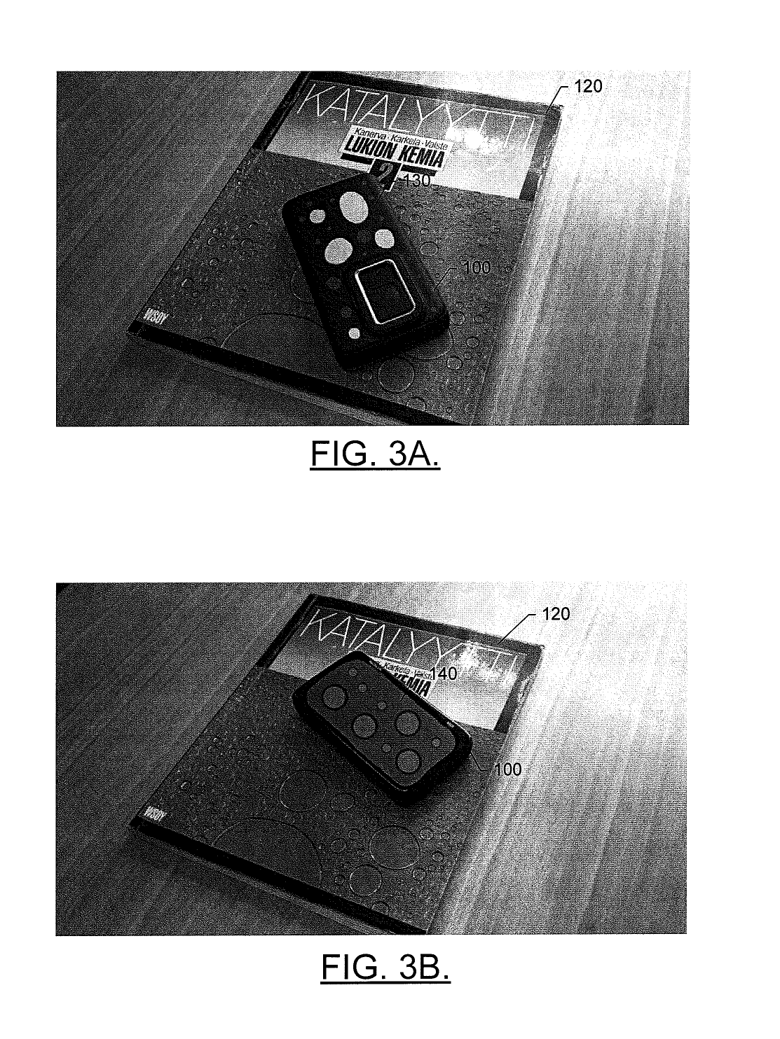

FIG. 3 illustrates an example of such a situation. As shown in FIG. 3, which includes FIGS. 3A and 3B, a mobile device 100 may be brought into proximity (in this case being placed on top of) an object (e.g., book 110). The book 110 may have a pattern associated therewith on the front cover. In the example of FIG. 3, a tag associated with the book (e.g., in the spine or embedded in the book cover or sleeve) may be used to communicate graphical information to the mobile device 100 to indicate graphical data that can be used to generate the same pattern that is on the cover of the book 110 onto a display of the mobile device 100. In the example of FIG. 3A, the pattern is displayed on a secondary display of the mobile device 100, which forms a skin 130 for the device. In the example of FIG. 3B, the front display 140 (or primary display) of the mobile device 100 is used to display the pattern.

In an example embodiment, tags may be placed in one or more objects and graphical information (e.g., the program code and/or data downloadable from each tag) may be predetermined such that any device entering into proximity with the object (and its tag) will receive corresponding graphical information and generate a graphical display on the secondary display 82 based on the graphical information such that the graphical information associated with any particular object (and its tag) is relatively fixed. For example, an object with a particular pattern displayed on the object itself may have a tag associated therewith that provides graphical information for generating the particular pattern on the secondary display 82 of any device that touches the object. The graphical information may be stored in some cases within a few kilobytes of data or in a compressed file (e.g., gzip).

In some examples, objects may have a particular temporal, situational, or locational significance and a pattern or other graphical display reflective of a theme corresponding to the temporal, situational or locational significance may be generated on the displays of proximate devices. For example, temporally significant themes may include colors, images or patterns that are indicative of the time of day (e.g., darker colors at night and brighter colors during mid day), holiday motifs that are based on the calendar date being proximate to a holiday, and/or the like. Situational themes may be associated with objects such as books, movie posters, retail items, museum pieces or various other objects and tags associated with the respective objects may communicate graphics information that may cause the secondary display 82 to generate graphical displays that are determined based on the situational theme associated with the object. For example, love stories may generate graphics relating to hearts or warm and inviting colors and/or patterns, while horror stories may generate graphics that are dark or chaotic and other objects may have tags that generate graphics that are in some way reflective of the situation described in, by or associated with the object. Locational themes may be related to the current location of the object or the location of origin of the object and may give the user of the mobile terminal 10 some indication as to the user's current location, the object's location of origin, or a theme associated with the current location or location of origin of the object. In an example case, a movie ticket may include a tag that provides graphics or a theme about the movie. The tag could alternatively be provided in the movie theater seat or at the entrance to the theater or any other location associated with the movie. As yet another example, a game disk (e.g., a CD) may include a tag that generates graphics about the game. Thus, while shopping for example, the user may experience some graphics about the game.

In some embodiments, the graphics information downloaded from the object may direct the mobile terminal 10 to access information from a web site or other location (e.g., associated with service platform 40). For example, the graphics information may identify a web link and initiate browsing by the mobile terminal 10 so that the mobile terminal 10 receives graphics data from the web link and generates (e.g., via the graphics synthesizer 90) graphics based on the graphics data received from the web link. This may allow for more complicated graphics to be generated based on information received from the tag. In some cases, the graphics data that is sent to a mobile terminal 10 based on interaction with a tag associated with an object may be fixed (e.g., every device that interacts with the tag may receive the same graphics information each time). However, since the graphics data may be provided from a web service (e.g., via service platform 40) in some cases, the web service may enable a party associated with the object to change the data that is to be communicated to devices for any reason. For example, the web service may change the graphics data provided based on temporal, situational or locational factors. In some cases, current temperature may be used to impact graphics data (e.g., blue tinted graphics for cold temperatures and red tinted graphics for hot temperatures), different shading may be applied for different times of the day (e.g., based on clock input or ambient light sensing), blurred graphics may be generated responsive to device motion as indicated by acceleration sensors, etc.

In an example embodiment, a portion of the graphics generated at a display of the mobile terminal 10 responsive to interaction with a tag may be generated directly from information received from the tag while another portion may be retrieved from the web (e.g., if a connection to the web is available). Animation graphics or graphics updates may be downloaded to enhance the capabilities of expression. In some cases, animation or display updating of the secondary display 82 may be provided at intervals such that energy consumption may be managed.

Accordingly, example embodiments may make a device such as the mobile terminal 10 appear to be responsive to its environment and thereby enable users to cause their devices to be expressive of their feelings or personalities based on the objects that they bring into proximity with their respective mobile terminals. Each tag may have a unique mood, feeling or theme associated therewith and thus, the user may express moods, feelings or themes via the objects (and thereby the tags) to which they bring their device near. In some cases, the graphics information provided to a device from a tag may be executed automatically upon receipt. However, in other cases, time criteria or user activity (e.g., a touch) may be used to initiate execution of downloaded data and the potential for generation of graphics.

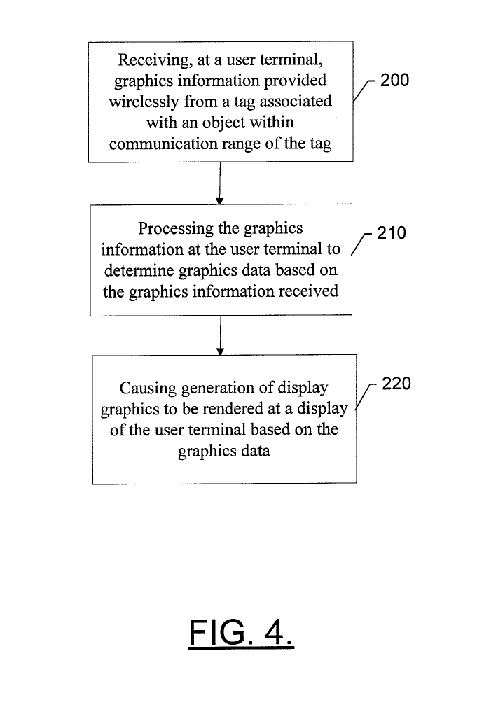

FIG. 4 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or network device and executed by a processor in the user terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 4, may include receiving, at a user terminal, graphics information provided wirelessly from a tag associated with an object within communication range of the tag at operation 200, processing the graphics information at the user terminal to determine graphics data based on the graphics information received at operation 210, and causing generation of display graphics to be rendered at a display of the user terminal based on the graphics data at operation 220.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In some embodiments, receiving graphics information may include receiving program code and data indicative of graphics to be presented at the display the graphics being illustrative of a mood, feeling or theme associated with the object. In an example embodiment, receiving graphics information may include receiving the graphics information via near field communication. In some cases, processing the graphics information may include compiling code locally to determine the graphics data. In an example embodiment, processing the graphics information may include retrieving the graphics data via a network using the graphics information to determine a location of the graphics data. In some embodiments, causing generation of display graphics to be rendered at the display of the user terminal may include generating graphics on an ink display forming a secondary display of the user terminal. The ink display may, in some situations, be disposed over an external portion of the user terminal as a dynamically expressive skin. In an example embodiment, causing generation of display graphics to be rendered at the display of the user terminal may include generating graphics comprising colors, patterns, textures, or images based on the graphics data to be rendered at the display.

In an example embodiment, an apparatus for performing the method of FIG. 4 above may comprise a processor (e.g., the processor 70) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-220 may comprise, for example, the graphics synthesizer 90. Additionally or alternatively, at least by virtue of the fact that the processor 70 may be configured to control or even be embodied as the graphics synthesizer 90, the processor 70 and/or a device or circuitry for executing instructions or executing an algorithm for processing information as described above may also form example means for performing operations 200-220.

In some cases, the operations (200-220) described above, along with any of the modifications may be implemented in a method that involves facilitating access to at least one interface to allow access to at least one service via at least one network. In such cases, the at least one service may be said to perform at least operations 200 to 220.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, at a user terminal, graphics information provided wirelessly from a tag associated with an object within communication range of the tag;
processing the graphics information at the user terminal to determine graphics data based on the graphics information received; and
causing generation of display graphics to be rendered at a display of the user terminal based on the graphics data.

2. The method of claim 1, wherein receiving graphics information comprises receiving program code and data indicative of graphics to be presented at the display the graphics being illustrative of a mood, feeling or theme associated with the object.

3. The method of claim 1, wherein receiving graphics information comprises receiving the graphics information via near field communication.

4. The method of claim 1, wherein processing the graphics information comprises compiling code locally to determine the graphics data.

5. The method of claim 1, wherein processing the graphics information comprises retrieving the graphics data via a network using the graphics information to determine a location of the graphics data.

6. The method of claim 1, wherein causing generation of display graphics to be rendered at the display of the user terminal comprises generating graphics on an ink display forming a display of the user terminal.

7. The method of claim 6, wherein the ink display is disposed over an external portion of the user terminal as a dynamically expressive skin.

8. The method of claim 1, wherein causing generation of display graphics to be rendered at the display of the user terminal comprises generating graphics comprising colors, patterns, textures, or images based on the graphics data to be rendered at the display.

9. An apparatus comprising at least one processor and at least one memory including computer program code, the at least one memory and the computer program code configured to, with the at least one processor, cause the apparatus at least to:
receive, at a user terminal, graphics information provided wirelessly from a tag associated with an object within communication range of the tag;
process the graphics information at the user terminal to determine graphics data based on the graphics information received; and
cause generation of display graphics to be rendered at a display of the user terminal based on the graphics data.

10. The apparatus of claim 9, wherein the at least one memory and computer program code are configured to, with the at least one processor, cause the apparatus to receive graphics information by receiving program code and data indicative of graphics to be presented at the display the graphics being illustrative of a mood, feeling or theme associated with the object.

11. The apparatus of claim 9, wherein the at least one memory and computer program code are configured to, with the at least one processor, cause the apparatus to receive graphics information by receiving the graphics information via near field communication.

12. The apparatus of claim 9, wherein the at least one memory and computer program code are configured to, with the at least one processor, cause the apparatus to process the graphics information by compiling code locally to determine the graphics data.

13. The apparatus of claim 9, wherein the at least one memory and computer program code are configured to, with the at least one processor, cause the apparatus to process the graphics information by retrieving the graphics data via a network using the graphics information to determine a location of the graphics data.

14. The apparatus of claim 9, wherein the at least one memory and computer program code are configured to, with the at least one processor, cause the apparatus to cause generation of display graphics to be rendered at the display of the user terminal by generating graphics on an ink display forming a display of the user terminal.

15. The apparatus of claim 14, wherein the ink display is disposed over an external portion of the user terminal as a dynamically expressive skin.

16. The apparatus of claim 9, wherein the at least one memory and computer program code are configured to, with the at least one processor, cause the apparatus to cause generation of display graphics to be rendered at the display of the user terminal by generating graphics comprising colors, patterns, textures, or images based on the graphics data to be rendered at the display.

17. The apparatus of claim 9, wherein the apparatus is a mobile terminal and further comprises user interface circuitry configured to facilitate user control of at least some functions of the mobile terminal.

18. A computer program product comprising at least one computer-readable storage medium having computer-executable program code instructions stored therein, the computer-executable program code instructions including program code instructions that when executed at least cause an apparatus to:
receive, at a user terminal, graphics information provided wirelessly from a tag associated with an object within communication range of the tag;
process the graphics information at the user terminal to determine graphics data based on the graphics information received; and
cause generation of display graphics to be rendered at a display of the user terminal based on the graphics data.

19. The computer program product of claim 18, wherein program code instructions for receiving target information include instructions for receiving graphics information include instructions for receiving program code and data indicative of graphics to be presented at the display the graphics being illustrative of a mood, feeling or theme associated with the object.

20. The computer program product of claim 18, wherein program code instructions for causing generation of display graphics to be rendered at the display of the user terminal include instructions for generating graphics on an ink display forming a display of the user terminal, the ink display being disposed over an external portion of the user terminal as a dynamically expressive skin.
